(19) United States
(12) Patent Application Publication
(10) Pub. No.: US 2025/0212095 A1
(43) Pub. Date: Jun. 26, 2025

(54) TSN CONFIGURATION AND MANAGEMENT IN A HYBRID TOPOLOGY USING SDN

(71) Applicants: Mythili Hegde, Bangalore (IN); Anshu Agarwal, Bangalore (IN); Jay Vishnu Gupta, Bengaluru (IN); Sagar Gupta, Ghaziabad (IN); Srinivas Krovvidi, Hyderabad (IN); Vatsala Pattanaik, Bangalore (IN)

(72) Inventors: Mythili Hegde, Bangalore (IN); Anshu Agarwal, Bangalore (IN); Jay Vishnu Gupta, Bengaluru (IN); Sagar Gupta, Ghaziabad (IN); Srinivas Krovvidi, Hyderabad (IN); Vatsala Pattanaik, Bangalore (IN)

(21) Appl. No.: 18/394,325

(22) Filed: Dec. 22, 2023

(51) Int. Cl. H04W 48/16; H04W 36/00; H04W 36/30; H04W 36/32

(52) U.S. Cl. CPC H04W 48/16; H04W 36/00837; H04W 36/30; H04W 36/324

(57) ABSTRACT

A time-sensitive network (TSN) controller can include a first interface to a network exposure function (NEF) to receive information regarding an external network. The TSN controller can further include a second interface to a software defined network (SDN) controller to receive topology and parameters to determine features of a network topology. The TSN controller can further include processing circuitry coupled to the first interface and the second interface to determine configuration settings. The TSN controller can provide the configuration settings to a user configuration module (CUC) and a network configuration module (CNC) to configure end stations based on the network information and the network topology.

### TECHNICAL FIELD

Embodiments pertain to wireless networks and wireless communications. Some embodiments relate to mechanisms to enhance wireless time-sensitive networking (TSN) configuration and management in hybrid topologies.

### BACKGROUND

Many distributed time-sensitive applications (e.g., medical, robotics, industry automation, and extended/virtual/augmented reality) have strict and low latency requirements for compute and networking tasks. Transmitting data with low latency and jitter is important for such applications. Time-sensitive networking (TSN) standards and solutions for wired (e.g., Ethernet) and wireless (e.g., Wi-Fi and 5G) networks have been developed as means to ensure deterministic connectivity services that implement low latency and jitter. However, configuring communication in networks with both wired and wireless devices can be challenging.

### BRIEF DESCRIPTION OF THE DRAWINGS

The present disclosure is illustrated by way of example and not limitation in the figures of the accompanying drawings, in which like references indicate similar elements and in which:

FIG. 1 is a network diagram illustrating an example network environment for time-sensitive networking (TSN), in accordance with some aspects of the disclosure.

FIG. 2 is a diagram of a wired-wireless TSN architecture, in accordance with some aspects of the disclosure.

FIG. 3 is a flow diagram depicting dynamic reconfiguration using a TSN facilitator in accordance with some aspects of the disclosure.

FIG. 4 illustrates a 5G logical bridge in accordance with some aspects of the disclosure.

FIG. 5 illustrates a block diagram of an example machine upon which any one or more of the techniques (e.g., methodologies) discussed herein may perform.

FIG. 6 illustrates a block diagram of an example wireless device upon which any one or more of the techniques (e.g., methodologies or operations) discussed herein may perform.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in or substituted for, those of other embodiments. Embodiments outlined in the claims encompass all available equivalents of those claims.

IEEE deterministic networking is referred to collectively as Time Sensitive Networking (TSN). Despite recent advances in wireless technologies, delivering wire-equivalent reliable, and secure wireless communications with time guarantees to be used in time-safety critical systems remains a significant challenge. The challenge is especially noticeable with hybrid topologies that include both wired and wireless TSN nodes, as can often occur in industrial applications. Wireless systems have several benefits including enabling flexibility, reducing wiring costs as well as enabling mobility. However, mobility adds new challenges because TSN requires minimum connectivity disruptions maintaining latency, high reliability, and time synchronization.

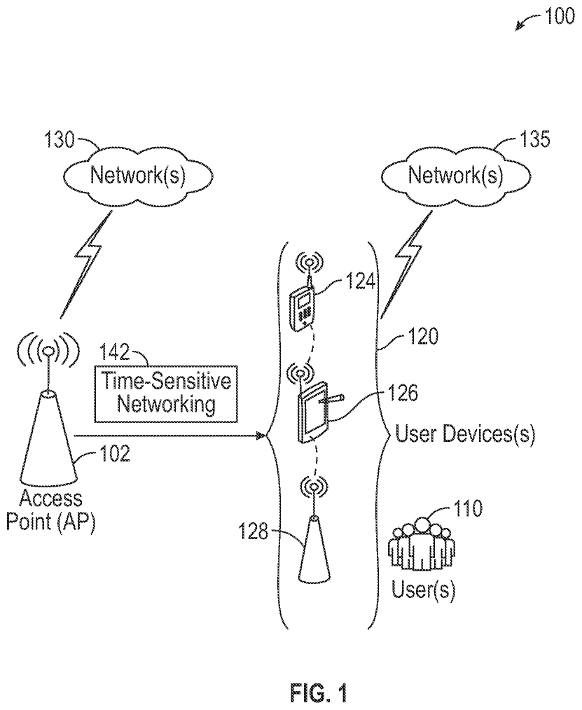

FIG. 1 is a network diagram illustrating an example network environment for time-sensitive networking (TSN), in accordance with some embodiments. Wireless network 100 may include one or more user devices 120 and at least one access point (AP) 102 or other network element, which may communicate in accordance with any communication standards, wired or wireless, including IEEE 802.11, cellular standards, or Ethernet. The one or more user devices 120 may be mobile devices that are non-stationary (e.g., not having fixed locations) or may be stationary devices.

The one or more user devices 120 and/or at least one AP 102 may be operable by one or more users 110. It should be noted that any addressable unit may be a station (STA). An STA may take on multiple distinct characteristics, each of which shapes its function. For example, a single addressable unit might simultaneously be a portable STA, a quality-of-service (QOS) STA, a dependent STA, and a hidden STA. The one or more user devices 120 and the at least one AP 102 may be STAs. The one or more user devices 120 and/or the at least one AP 102 may operate as a personal basic service set (PBSS) control point/access point (PCP/AP). The one or more user devices 120 (e.g., user device 124, user device 126, or user device 128) and/or the at least one AP 102 may include any suitable processor-driven device including, but not limited to, a mobile device or a non-mobile, e.g., a static device. For example, the one or more user devices 120 and/or the at least one AP 102 may include, user equipment (UE), an STA, an AP, or another device. The one or more user device 120 and/or the at least one AP 102 may also include mesh stations in, for example, a mesh network, in accordance with one or more IEEE 802.11 standards and/or 3GPP standards.

Any of the one or more user devices 120 (e.g., user devices 124-128) and the at least one AP 102 may be configured to communicate with each other via one or more communications networks 130 and/or 135, which can be wireless or wired networks. The one or more user devices 120 may also communicate peer-to-peer or directly with each other with or without the at least one AP 102. Any of the one or more communications networks 130 and/or 135 may include but is not limited to, any one of a combination of different types of suitable communications networks such as broadcasting networks, cable networks, public networks (e.g., the Internet), private networks, wireless networks, cellular networks, or any other suitable private and/or public networks.

In one embodiment, and with reference to FIG. 1, the at least one AP 102 may facilitate time-sensitive networking 142 with the one or more user devices 120 using the disclosed techniques. It is understood that the above descriptions are for purposes of illustration and are not meant to be limiting.

Many distributed time-sensitive applications (e.g., robotics, industry automation, extended/virtual/augmented reality) have strict and low latency requirements for compute and networking tasks. Transmitting data with low latency and jitter is important. Time-sensitive networking (TSN) standards and solutions for wired (Ethernet) and wireless (Wi-Fi and 5G) networks have been developed as means to ensure deterministic connectivity services that ensure low latency and jitter. However, challenges occur when networks include both wired and wireless networks (as in, e.g., “hybrid” topologies) and furthermore mobility adds new challenges because TSN requires minimum connectivity disruptions to maintain latency, high reliability, and time synchronization.

Accordingly, successful wireless TSN depends on configuration of network and mobility management. However, this configuration and management presents questions concerning the methods and systems for obtaining cellular (e.g., 5G) virtual bridge related information. Further related to cellular support, concerns can arise around determining and mitigating impact on 5G systems when TSN support is introduced due to mobility and determining to what extent TSN can be supported when there is mobility. Systems apparatuses and methods according to aspects of the disclosure address these and other concerns by providing a TSN controller (e.g., TSN “facilitator”) as described in more detail below.

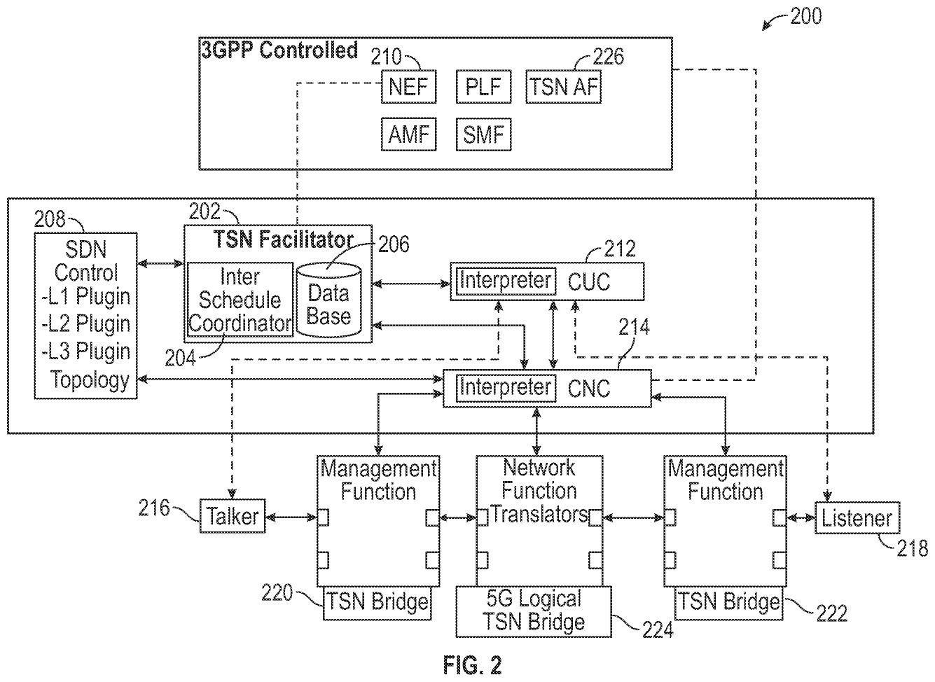

FIG. 2 is a diagram of a software defined network (SDN) based unified TSN configuration and management framework 200 using a TSN facilitator 202 in accordance with some embodiments. The framework 200 is a control plane framework and the TSN facilitator 202 orchestrates configuration and management TSN nodes in a hybrid topology. The TSN facilitator 202 includes an Inter Schedule Coordinator 204 and a database 206. The TSN facilitator 202 can interact with an SDN Controller 208 using Northbound application programming interfaces (APIs). These APIs can use standard protocols, such as RESTful APIs or SOAP APIs.

SDN controller 208 can help in configuring time sensitive nodes for 5G and Ethernet by providing a centralized control plane for the network. This allows the controller 208 to optimize the network traffic. Common information stored in an SDN controller 208 that can be leveraged by the TSN facilitator 202 includes network topology. With respect to network topology, the SDN controller 208 has a complete view of the network topology to make routing decisions. This includes information about the location of all network devices, the links between them, and the capabilities of each device.

Other information stored in an SDN controller 208 can include flow rules. Flow rules are used to control the flow of traffic in the network. They specify the source and destination addresses, the ports, and the QoS parameters for each flow. Still further information stored in an SDN controller 208 can include policies. Policies are used to define the rules for how the network should be managed. The SDN controller 208 can also store telemetry data. Telemetry data is used to monitor the health of the network. This includes things like traffic statistics, link utilization, and device health information.

The TSN facilitator 202 shall interact with a 5G Network Exposure Function (NEF) 210. NEF 210 is logical entity that exposes the capabilities of the 5G network to external entities, such as the TSN facilitator 202. NEF 210 can provide a centralized view of the 5G network. This allows the TSN facilitator 202 to see all the resources in the network, such as links, nodes, and flows. Some of the TSN related parameters exposed by NEF 210 are listed in Table 1, though it will be understood that Table 1 is not an exhaustive list and other parameters can be exposed by NEF 210. This information can be used to configure and manage TSN traffic in the network dynamically. The TSN facilitator 202 and NEF 210 can interact using an Nnef interface.

TABLE 1
NEF exposed TSN parameters

| NEF exposed TSN parameter | description |
|---|---|
| tsn-clock-accuracy | Accuracy of network clock |
| tsn-jitter | Jitter of network clock |
| tsn-latency | Network latency |
| tsn-bandwidth-usage | Bandwidth usage by different types of |
| | traffic in the network |
| tsn-traffic-patterns | Patterns of traffic flow in the network |

The TSN facilitator 202 shall interact with a centralized user configuration (CUC) node 212, and a central network controller (CNC) 214 using a Uni interface. According to the current standardization landscape in IEEE802.1Q CNC 214 comprises a centralized component that configures network resources on behalf of TSN applications (users).

The CUC 212 comprises a centralized entity that discovers end stations, retrieves end station capabilities and user requirements, and configures TSN features in end stations. The protocols that the CUC 212 uses for communication with end stations are specific to the user application. A CUC 212 exchanges information with a CNC 214 to configure TSN features on end stations' behalf. The CUC 212 can receive information about traffic stream characteristics from the talker devices 216 and the listener devices 218 and pass this information to CNC 210.

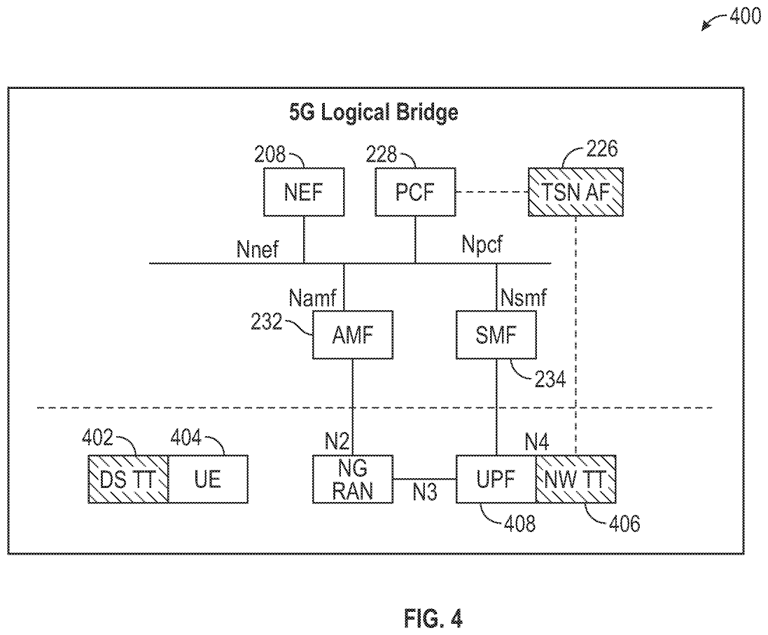

TSN bridge 220 and TSN bridge 222 can manage time synchronization, schedule traffic, and connect endpoints. 5G logical bridge 224 and other components such as TSN AF 226, PCF 228, AMF 232 and SMF 234 are described in more detail with respect to FIG. 4 later herein.

The Inter Schedule Coordinator 204 and database 206 can store the information retrieved from SDN 208 NEF 210 interactions and pass the information to CUC 212 and CNC 214, which further leverages the information for dynamic TSN configuration and management to realize end-to-end TSN flow.

Aspects of the disclosure also provide methods to reconfigure TSN by detecting and reporting quality of service (QOS) failures and self-correcting the TSN 5G network through use of the TSN facilitator 202. The TSN facilitator 202 can handle interworking aspects including TSN configuration, mobility, and interoperability. The TSN facilitator 202 shall interact with CUC 212 and CNC 214. Through these interactions, the TSN facilitator 202 can help enable and ensure wire-equivalent reliable and secure wireless communications with time guarantees and self-correction in a hybrid (e.g., both wired and wireless) TSN topology. The TSN facilitator 202 can reduce or eliminate link failure/QoS negotiation issues.

Example uses of dynamic reconfiguration in various scenarios is described below. First, in a link failure scenario, if the TSN facilitator 202 detects a link is unavailable, the TSN facilitator 202 can take corrective measure by re-routing the data/triggering handover. To do this, the TSN facilitator 202 can use SDN controller 208 parameters or NEF 210 parameters.

In a congestion scenario, the TSN facilitator 202 can use the traffic patterns to identify the traffic that is causing the congestion. The SDN controller 208 can then adjust the configuration of the network to reduce the congestion. To do this, the TSN facilitator 202 can use tsn-traffic-patterns parameters described in Table 1.

In a synchronization fault scenario, if tsn-clock-accuracy of a node reaches below an acceptable value, the TSN facilitator 202 can trigger handovers because clock accuracy most important factor in time synchronization requirement of TSN. The TSN facilitator 202 can use tsn-clock-accuracy and tsn-jitter parameters (described in Table 1) to detect this.

In a latency scenario, the TSN facilitator 202 can calculate end-to-end latency and pass latency correction to each node. If tsn-latency degrades, reconfiguration can be triggered immediately. The TSN facilitator 202 can work with SDN controller 208 and tsn-latency parameter (described in Table 1) regarding this scenario.

In a handover scenario, the TSN facilitator 202 can optimize handovers using SDN topology information provided by the SDN controller 208, as well as leveraging NEF 210 5G capabilities (see e.g., cellular handover standard descriptions and functionality).

In a security breach scenario, the TSN facilitator 202 can use the traffic patterns to identify the traffic that is associated with the breach. The SDN controller 208 can then block the traffic and prevent further attacks. The TSN facilitator 202 can use the tsn-traffic-patterns parameter (see Table 1 description) for implementation of this scenario.

In an overload scenario, the TSN facilitator 202 can ensure that the network is not overloaded and that time-sensitive flows are not being starved of bandwidth. In case of Overload, the TSN facilitator 202 can enable reconfiguration. The tsn-bandwidth-usage parameter can be used for this scenario.

In a mobility scenario, mobility can cause reconfiguration/handover to ensure end-to-end flow is realized. In a scenario in which artificial intelligence or machine learning assistance is to be provided by one or more TSN nodes or other component/s then network data analytics function (NWDAF) analytics can be exposed to NEF 210. This can be leveraged by the TSN facilitator 202 for AI/ML operations to enhance assistance towards CUC 212 and/or CNC 214.

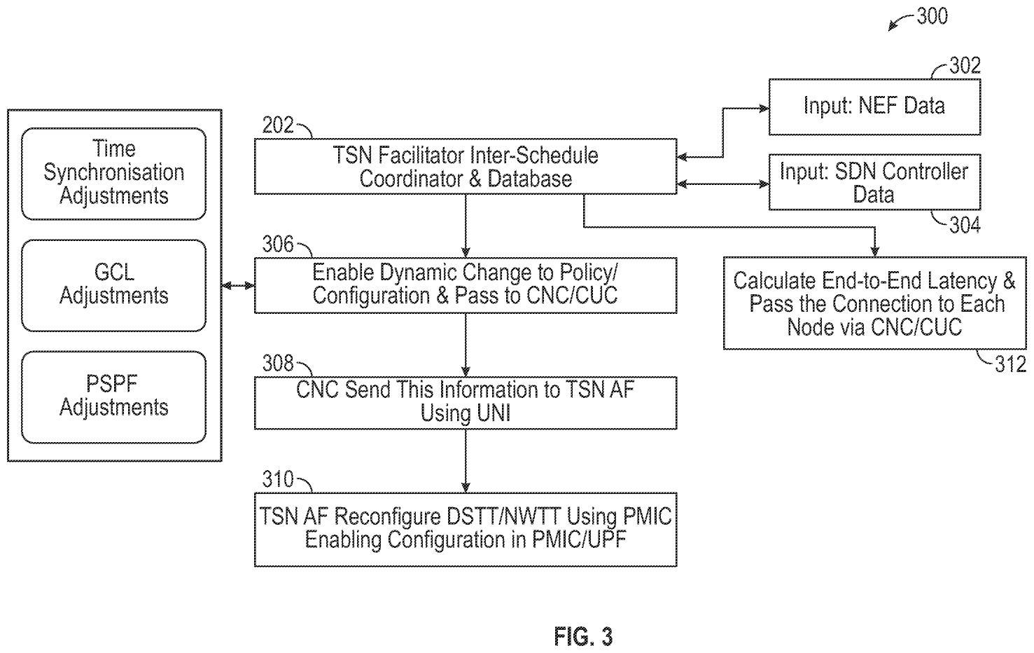

FIG. 3 is a flow diagram 300 depicting dynamic reconfiguration using a TSN facilitator 202 in accordance with some aspects of the disclosure. The flow diagram 300 depicts, at a high level, operations for fault detection & dynamic reconfiguration. In operations 302 and 304, the TSN facilitator 202 can receive input from NEF 210 and SDN Controller 208 (FIG. 2).

In operation 306, if the TSN facilitator 202 detects a fault or needs to reconfigure within the network based on the input/s 302, 304, then the TSN facilitator 202 performs correction by reconfiguring nodes using data from block 308 and reconfiguring nodes (leveraging CNC 214 and CUC 212) to reenable dynamic change to policy/configuration. If a link failure is detected, a handover can be triggered. At operation 308, the CNC 214 can pass configuration and policy information to a TSN application function (AF) using the UNI interface.

At operation 310, the TSN AF can reconfigure device side TSN translators (DSTT) or network side TSN translators (NWTT) using PMIC to enable configuration in PMIC/UPF. With respect to NWTT and DSTT, FIG. 4 illustrates a TSN 5G logical bridge 400 in accordance with some aspects of the disclosure. FIG. 4 serves to illustrate component 224 (FIG. 2) in greater detail.

To Enable TSN over 5G, 5G is considered as TSN Logical bridge 400. 3GPP introduced DSTT 402 interacting with UE 404 and NWTT 406 interacting with network (user plane function (UPF 408)). These translators are responsible for TSN functionality. TSN AF 226 is used to interact with CUC 212 and/or CNC 214 (FIG. 2) using UNI interface and pass configurations to DSTT/NWTT using PMIC/BMIC.

Access and Mobility Management Function (AMF) 232 can perform registration, connection, reachability, and mobility management. AMF 232 can transport messages between UE 404 and SMF 234. Policy Control Function (PCF) 228 can provide policy rules to control plane functions. Session Management Function (SMF) 234 can perform session management and traffic steering at UPF.

Referring again to FIG. 3, at operation 312, the TSN facilitator 202 can calculates end-to-end Latency and pass correction to each node (leveraging CNC 214 and CUC 212). The TSN facilitator 202 can also use telemetry data to optimize future configurations.

Aspects of the disclosure as described herein provide unified ways handling TSN configuration for hybrid topologies.

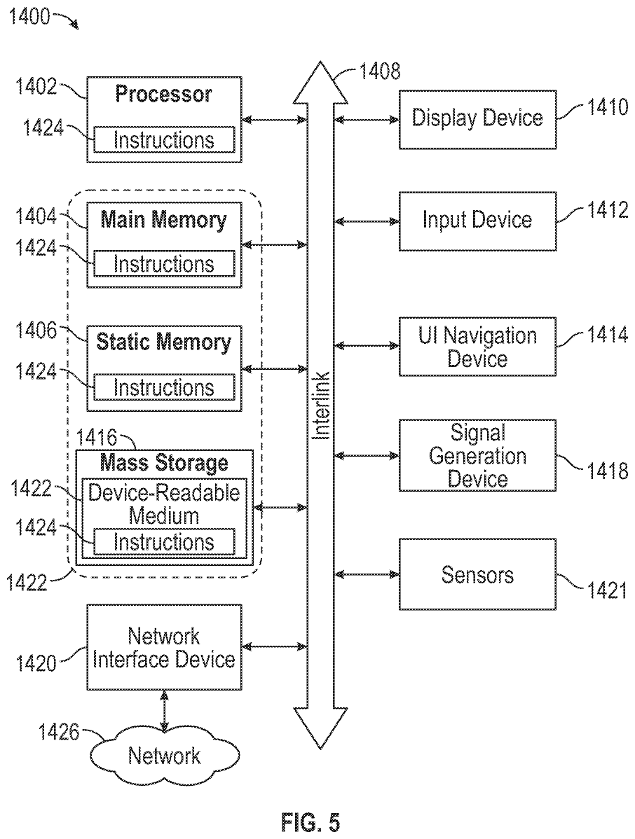

FIG. 5 illustrates a block diagram of an example machine 1400 upon which any one or more of the techniques (e.g., methodologies) discussed herein may perform. In alternative embodiments, the machine 1400 may operate as a standalone device or may be connected (e.g., networked) to other machines. In a networked deployment, machine 1400 may operate in the capacity of a server machine, a client machine, or both in server-client network environments. In an example, machine 1400 may act as a peer machine in a peer-to-peer (P2P) (or other distributed) network environment. The machine 1400 may be a personal computer (PC), a tablet PC, a set-top box (STB), a personal digital assistant (PDA), a portable communications device, a mobile telephone, a smartphone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Machine (e.g., computer system) 1400 may include a hardware processor 1402 (e.g., a central processing unit (CPU), a graphics processing unit (GPU), a hardware processor core, or any combination thereof), a main memory 1404, and a static memory 1406, some or all of which may communicate with each other via an interlink (e.g., bus) 1408.

Specific examples of main memory 1404 include Random Access Memory (RAM), and semiconductor memory devices, which may include, in some embodiments, storage locations in semiconductors such as registers. Specific examples of static memory 1406 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks.

The machine 1400 may further include a display device 1410, an input device 1412 (e.g., a keyboard), and a user interface (UI) navigation device 1414 (e.g., a mouse). In an example, the display device 1410, the input device 1412, and the UI navigation device 1414 may be a touch screen display. The machine 1400 may additionally include a storage device (e.g., drive unit) 1416, a signal generation device 1418 (e.g., a speaker), a network interface device 1420, and one or more sensors 1421, such as a global positioning system (GPS) sensor, compass, accelerometer, or other sensors. In some embodiments, the processor 1402 and/or instructions 1424 may comprise processing circuitry and/or transceiver circuitry.

The storage device 1416 may include a machine-readable medium 1422 on which is stored one or more sets of data structures or instructions 1424 (e.g., software) embodying or utilized by any one or more of the techniques or functions described herein. The instructions 1424 may also reside, completely or at least partially, within the main memory 1404, within static memory 1406, or the hardware processor 1402 during execution thereof by the machine 1400. In an example, one or any combination of the hardware processor 1402, the main memory 1404, the static memory 1406, or the storage device 1416 may constitute machine-readable media.

Specific examples of machine-readable media may include non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

While the machine-readable medium 1422 is illustrated as a single medium, the term “machine-readable medium” may include a single medium or multiple media (e.g., a centralized or distributed database, and/or associated caches and servers) configured to store instructions 1424.

An apparatus of the machine 1400 may be one or more of a hardware processor 1402 (e.g., a central processing unit (CPU), a graphics processing unit (GPU), a hardware processor core, or any combination thereof), a main memory 1404 and a static memory 1406, sensors 1421, the network interface device 1420, a display device 1410, an input device 1412, a UI navigation device 1414, a storage device 1416, instructions 1424, and a signal generation device 1418. The apparatus may be configured to perform one or more of the methods and/or operations disclosed herein. The apparatus may be intended as a component of machine 1400 to perform one or more of the methods and/or operations disclosed herein, and/or to perform a portion of one or more of the methods and/or operations disclosed herein. In some embodiments, the apparatus may include a pin or other means to receive power. In some embodiments, the apparatus may include power conditioning hardware.

The term “machine-readable medium” may include any medium that is capable of storing, encoding, or carrying instructions for execution by machine 1400 and that causes the machine 1400 to perform any one or more of the techniques of the present disclosure, or that is capable of storing, encoding or carrying data structures used by or associated with such instructions. Non-limiting machine-readable medium examples may include solid-state memories and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine-readable media may include non-transitory machine-readable media. In some examples, machine-readable media may include machine-readable media that is not a transitory propagating signal.

The instructions 1424 may further be transmitted or received over a communications network 1426 using a transmission medium via the network interface device 1420 utilizing any one of several transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others.

In an example, the network interface device 1420 may include one or more physical jacks (e.g., Ethernet, coaxial, or phone jacks) or one or more antennas to connect to the communications network 1426. The term “transmission medium” shall be taken to include any intangible medium that is capable of storing, encoding, or carrying instructions for execution by the machine 1400, and includes digital or analog communications signals or other intangible media to facilitate communication of such software.

Examples, as described herein, may include, or may operate on, logic or several components, modules, or mechanisms. Modules are tangible entities (e.g., hardware) capable of performing specified operations and may be configured or arranged in a certain manner. In an example, circuits may be arranged (e.g., internally or concerning external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. The software may accordingly configure a hardware processor, for example, to constitute a particular module at one instance of time and to constitute a different module at a different instance of time.

Some embodiments may be implemented fully or partially in software and/or firmware. This software and/or firmware may take the form of instructions contained in or on a non-transitory computer-readable storage medium. Those instructions may then be read and executed by one or more processors to enable the performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read-only memory (ROM); random access memory (RAM); magnetic disk storage media; optical storage media; flash memory, etc.

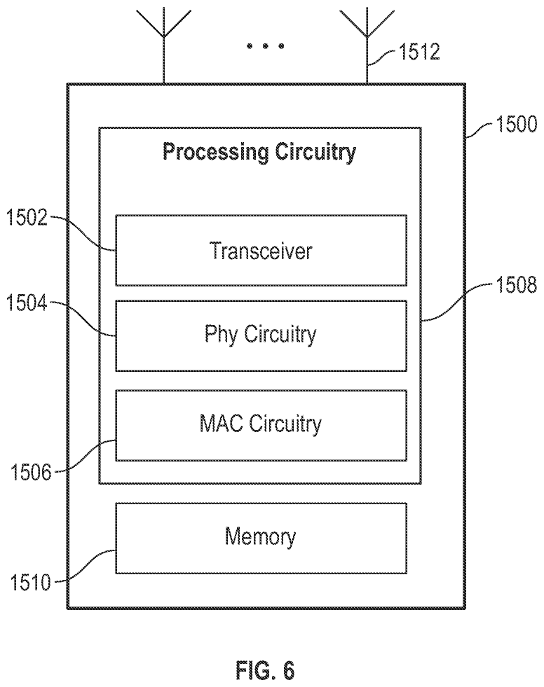

FIG. 6 illustrates a block diagram of an example wireless device 1500 upon which any one or more of the techniques (e.g., methodologies or operations) discussed herein may perform. The wireless device 1500 may be any of the UEs or other endpoints/nodes described with respect to FIGS. 1-5. The wireless device 1500 may be an example of machine 1400 as disclosed in conjunction with FIG. 5.

The wireless device 1500 may include processing circuitry 1508. The processing circuitry 1508 may include a transceiver 1502, physical layer circuitry (PHY circuitry) 1504, and MAC layer circuitry (MAC circuitry) 1506, one or more of which may enable transmission and reception of signals to and from other wireless devices using one or more antennas 1512. As an example, the PHY circuitry 1504 may perform various encoding and decoding functions that may include the formation of baseband signals for transmission and decoding of received signals. As another example, the transceiver 1502 may perform various transmission and reception functions such as the conversion of signals between a baseband range and a Radio Frequency (RF) range.

Accordingly, the PHY circuitry 1504 and the transceiver 1502 may be separate components or may be part of a combined component, e.g., processing circuitry 1508. In addition, some of the described functionality related to the transmission and reception of signals may be performed by a combination that may include one, any, or all of the PHY circuitry 1504 the transceiver 1502, MAC circuitry 1506, memory 1510, and other components or layers. The MAC circuitry 1506 may control access to the wireless medium. The wireless device 1500 may also include memory 1510 arranged to perform the operations described herein, e.g., some of the operations described herein may be performed by instructions stored in memory 1510.

The one or more antennas 1512 (some embodiments may include only one antenna) may comprise one or more directional or omnidirectional antennas, including, for example, dipole antennas, monopole antennas, patch antennas, loop antennas, microstrip antennas, or other types of antennas suitable for transmission of RF signals. In some multiple-input multiple-output (MIMO) embodiments, the one or more antennas 1512 may be effectively separated to take advantage of spatial diversity and the different channel characteristics that may result.

One or more of the memory 1510, the transceiver 1502, the PHY circuitry 1504, the MAC circuitry 1506, the one or more antennas 1512, and/or the processing circuitry 1508 may be coupled with one another. Moreover, although memory 1510, the transceiver 1502, the PHY circuitry 1504, the MAC circuitry 1506, the one or more antennas 1512 are illustrated as separate components, one or more of memory 1510, the transceiver 1502, the PHY circuitry 1504, the MAC circuitry 1506, the one or more antennas 1512 may be integrated into an electronic package or chip.

In some embodiments, the wireless device 1500 may be a mobile device as described in conjunction with FIG. 5. In some embodiments, the wireless device 1500 may be configured to operate under one or more wireless communication standards as described herein. In some embodiments, the wireless device 1500 may include one or more of the components as described in conjunction with FIG. 5 (e.g., the display device 1410, input device 1412, etc.) Although the wireless device 1500 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application-specific integrated circuits (ASICs), radio-frequency integrated circuits (RFICs), and combinations of various hardware and logic circuitry for performing at least the functions described herein. In some embodiments, the functional elements may refer to one or more processes operating on one or more processing elements.

In some embodiments, an apparatus of or used by the wireless device 1500 may include various components of the wireless device 1500 as shown in FIG. 6 and/or components from FIGS. 1-5. Accordingly, techniques and operations described herein that refer to the wireless device 1500 may apply to an apparatus for a wireless device 1500 in some embodiments. In some embodiments, the wireless device 1500 is configured to decode and/or encode signals, packets, and/or frames as described herein, e.g., PPDUs.

In some embodiments, the MAC circuitry 1506 may be arranged to contend for a wireless medium during a contention period to receive control of the medium for a HE TXOP and encode or decode an HE PPDU. In some embodiments, the MAC circuitry 1506 may be arranged to contend for the wireless medium based on channel contention settings, a transmitting power level, and a clear channel assessment level (e.g., energy detect level).

The PHY circuitry 1504 may be arranged to transmit signals following one or more communication standards described herein. For example, the PHY circuitry 1504 may be configured to transmit a HE PPDU. The PHY circuitry 1504 may include circuitry for modulation/demodulation, upconversion/downconversion, filtering, amplification, etc. In some embodiments, the processing circuitry 1508 may include one or more processors. The processing circuitry 1508 may be configured to perform functions based on instructions being stored in a RAM or ROM or based on special-purpose circuitry. The processing circuitry 1508 may include a processor such as a general-purpose processor or a special-purpose processor. The processing circuitry 1508 may implement one or more functions associated with one or more antennas 1512, the transceiver 1502, the PHY circuitry 1504, the MAC circuitry 1506, and/or the memory 1510. In some embodiments, the processing circuitry 1508 may be configured to perform one or more of the functions/operations and/or methods described herein.

In mmWave technology, communication between a station and an access point may use associated effective wireless channels that are highly directionally dependent. To accommodate the directionality, beamforming techniques may be utilized to radiate energy in a certain direction with a certain beam width to communicate between two devices. The directed propagation concentrates transmitted energy toward a target device to compensate for significant energy loss in the channel between the two communicating devices. Using directed transmission may extend the range of the millimeter-wave communication versus utilizing the same transmitted energy in omnidirectional propagation.

Examples, as described herein, may include, or may operate on, logic or several components, modules, or mechanisms. Modules are tangible entities (e.g., hardware) capable of performing specified operations and may be configured or arranged in a certain manner. In an example, circuits may be arranged (e.g., internally or concerning external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using the software, the general-purpose hardware processor may be configured as respective different modules at different times. The software may accordingly configure a hardware processor, for example, to constitute a particular module at one instance of time and to constitute a different module at a different instance of time.

Some embodiments may be implemented fully or partially in software and/or firmware. This software and/or firmware may take the form of instructions contained in or on a non-transitory computer-readable storage medium. Those instructions may then be read and executed by one or more processors to enable the performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read-only memory (ROM); random access memory (RAM); magnetic disk storage media; optical storage media; flash memory, etc.

The above-detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either concerning a particular example (or one or more aspects thereof) or concerning other examples (or one or more aspects thereof) shown or described herein.

Publications, patents, and patent documents referred to in this document are incorporated by reference herein in their entirety, as though individually incorporated by reference. In the event of inconsistent usage between this document and those documents so incorporated by reference, the usage in the incorporated reference(s) is supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels and are not intended to suggest a numerical order for their objects.

The embodiments as described above may be implemented in various hardware configurations that may include a processor for executing instructions that perform the techniques described. Such instructions may be contained in a machine-readable medium such as a suitable storage medium or a memory or other processor-executable medium.

The embodiments as described herein may be implemented in several environments such as part of a wireless local area network (WLAN), 3rd Generation Partnership Project (3GPP) Universal Terrestrial Radio Access Network (UTRAN), or Long-Term-Evolution (LTE) or a Long-Term-Evolution (LTE) communication system, although the scope of the disclosure is not limited in this respect.

Antennas referred to herein may comprise one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, antennas may be effectively separated to take advantage of spatial diversity and the different channel characteristics that may result between each antenna and the antennas of a transmitting station. In some MIMO embodiments, antennas may be separated by up to 1/10 of a wavelength or more.

Described implementations of the subject matter can include one or more features, alone or in combination as illustrated below by way of examples.

Example 1 is a time-sensitive network (TSN) controller comprising: a first interface to a network exposure function (NEF) to receive information regarding an external network, and a second interface to a software defined network (SDN) controller configured to receive topology and parameters to determine features of a network topology; and processing circuitry coupled to the first interface and the second interface to determine configuration settings to provide to a user configuration module (CUC) and a network configuration module (CNC) to configure end stations based on the network information and the network topology.

In Example 2, the subject matter of Example 1 can optionally include an inter schedule coordinator and database configured to store data received from the NEF and SDN controller.

In Example 3, the subject matter of any of Examples 1-2 can optionally include wherein the processing circuitry is configured to detect a quality of service (QOS) failure in at least one of the end stations or network and to provide reconfiguration parameters based on the detecting.

In Example 4, the subject matter of Example 3 can optionally include wherein the QoS failure includes a detection that a link is unavailable and wherein reconfiguration includes rerouting data or triggering a handover.

In Example 5, the subject matter of Example 3 can optionally include wherein the QoS failure includes congestion and wherein the processing circuitry is configured to identify traffic causing the congestion.

In Example 6, the subject matter of Example 3 can optionally include wherein the QoS failure includes a synchronization fault and wherein reconfiguration includes triggering a handover.

In Example 7, the subject matter of Example 3 can optionally include wherein the QOS failure includes a high latency scenario and wherein the processing circuitry is configured to pass latency correction information to at least one user node on the network.

In Example 8, the subject matter of Example 3 can optionally include wherein a mobility scenario is detected and wherein the processing circuitry is configured to perform a reconfiguration or a handover upon detecting the mobility scenario.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined regarding the appended claims, along with the full scope of equivalents to which such claims are entitled.

The Abstract is provided to comply with 37 C.F.R. Section 1.72 (b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A time-sensitive network (TSN) controller comprising:
a first interface to a network exposure function (NEF) to receive information regarding an external network, and a second interface to a software defined network (SDN) controller configured to receive topology and parameters to determine features of a network topology; and
processing circuitry coupled to the first interface and the second interface to determine configuration settings to provide to a user configuration module (CUC) and a network configuration module (CNC) to configure end stations based on the network information and the network topology.

2. The TSN controller of claim 1 further comprising an inter schedule coordinator and database configured to store data received from the NEF and SDN controller.

3. The TSN controller of claim 1, wherein the processing circuitry is configured to detect a quality of service (QOS) failure in at least one of the end stations or network and to provide reconfiguration parameters based on the detecting.

4. The TSN controller of claim 3, wherein the QOS failure includes a detection that a link is unavailable and wherein reconfiguration includes rerouting data or triggering a handover.

5. The TSN controller of claim 3, wherein the QoS failure includes congestion and wherein the processing circuitry is configured to identify traffic causing the congestion.

6. The TSN controller of claim 3, wherein the QOS failure includes a synchronization fault and wherein reconfiguration includes triggering a handover.

7. The TSN controller of claim 3, wherein the QOS failure includes a high latency scenario and wherein the processing circuitry is configured to pass latency correction information to at least one user node on the network.

8. The TSN controller of claim 3, wherein a mobility scenario is detected and wherein the processing circuitry is configured to perform a reconfiguration or a handover upon detecting the mobility scenario.

9. A non-transitory computer-readable medium including instructions that, when executed on a controller, cause the controller to perform operations including:
providing a first interface to a network exposure function (NEF) to receive information regarding an external network, and a second interface to a software defined network (SDN) controller configured to receive topology and parameters to determine features of a network topology; and
determining configuration settings to provide to a user configuration module (CUC) and a network configuration module (CNC) to configure end stations based on the network information and the network topology.

10. The non-transitory computer-readable medium of claim 9 wherein the operations further comprise storing data received from the NEF and SDN controller.

11. The non-transitory computer-readable medium of claim 9 wherein the operations further comprise detecting a quality of service (QOS) failure in at least one of the end stations or network and to provide reconfiguration parameters based on the detecting.

12. The non-transitory computer-readable medium of claim 11, wherein the QOS failure includes a detection that a link is unavailable and wherein reconfiguration includes rerouting data or triggering a handover.

13. The non-transitory computer-readable medium of claim 11, wherein the QOS failure includes congestion and wherein the operations further include identifying traffic causing the congestion.

14. The non-transitory computer-readable medium of claim 11, wherein the QOS failure includes a synchronization fault and wherein reconfiguration includes triggering a handover.

15. The non-transitory computer-readable medium of claim 11, wherein the QOS failure includes a high latency scenario and wherein the operations further include passing latency correction information to at least one user node on the network.

16. A device comprising:
a first interface to a network exposure function (NEF) to receive information regarding an external network, and a second interface to a software defined network (SDN) controller configured to receive topology and parameters to determine features of a network topology;
processing circuitry coupled to the first interface and the second interface to determine configuration settings to provide to a user configuration module (CUC) and a network configuration module (CNC) to configure end stations based on the network information and the network topology; and
an inter schedule coordinator and database configured to store data received from the NEF and SDN controller.

17. The device of claim 16, wherein the processing circuitry is configured to detect a quality of service (QOS) failure in at least one of the end stations or network and to provide reconfiguration parameters based on the detecting.

18. The device of claim 17, wherein the QOS failure includes a detection that a link is unavailable and wherein reconfiguration includes rerouting data or triggering a handover.

19. The device of claim 17, wherein the QoS failure includes congestion and wherein the processing circuitry is configured to identify traffic causing the congestion.

20. The device of claim 17, wherein a mobility scenario is detected and wherein the processing circuitry is configured to perform a reconfiguration or a handover upon detecting the mobility scenario.
